(19) United States
(12) Patent Application Publication
(10) Pub. No.: US 2022/0194364 A1
(43) Pub. Date: Jun. 23, 2022

(54) DRIVER ASSISTANCE SYSTEM, DRIVER ASSISTANCE METHOD, AND COMPUTER READABLE STORAGE MEDIUM

(71) Applicant: TOYOTA JIDOSHA KABUSHIKI KAISHA, Toyota-shi Aichi-ken (JP)

(72) Inventors: Katsumi Ohno, Hachioji-shi Tokyo-to (JP); Sei Miyazaki, Susono-shi Shizuoka-ken (JP); Fumio Sugaya, Susono-shi (JP); Satoshi Nakamura, Susono-shi Shizuoka-ken (JP); Noriaki Hasegawa, Izunokuni-shi Shizuoka-ken (JP)

(21) Appl. No.: 17/553,077

(22) Filed: Dec. 16, 2021

(30) Foreign Application Priority Data
Dec. 22, 2020 (JP) 2020-212799

(51) Int. Cl. B60W 30/09

(52) U.S. Cl. CPC B60W 30/09; B60W 2710/20; B60W 2710/18

(57) ABSTRACT

The driver assistance system according to the present disclosure extracts, from information relating to a peripheral situation of the vehicle, risk target information relating to a risk target that is an existence causing a collision risk to the vehicle, obtains influence factor information relating to an influence factor that is a factor existing separately from the risk target and influencing the collision risk, determines a risk value obtained by quantifying the collision risk based on the risk target information and the influence factor information, and determines, based on the risk value, a manipulated variable of an actuator for controlling movement of the vehicle so as to decrease the collision risk.

### CROSS-REFERENCE TO RELATED APPLICATION

The present application claims priority under 35 U.S.C. § 119 to Japanese Patent Application No. 2020-212799, filed Dec. 22, 2020, the contents of which application are incorporated herein by reference in their entirety.

### BACKGROUND

### Field

The present disclosure relates to a driver assistance system, a driver assistance method, and a computer readable storage medium storing a program for assisting driving of a vehicle.

### Background Art

When a pedestrian or bike suddenly jumps out of a blind spot of a wall or parked vehicle, there is a collision risk because a conventional AEBS brake cannot fully decelerate an ego vehicle and avoid the pedestrian and the like. Therefore, JP2017-206117A proposes a “risk field method” in which a predicted collision speed after the operation of the AEBS is defined as a potential risk value. The AEBS is operated when the position of the blind spot is recognized and a virtual pedestrian jumping out of the blind spot is assumed from the distance, the lateral clearance, and the relative speed between the ego vehicle and the blind spot. If deceleration or lateral avoidance is performed until the assumed potential risk value (the predicted collision speed) becomes zero, it is possible to safely pass through the blind spot.

### SUMMARY

For example, when steering is performed to avoid potential risks on a general road, sufficient avoidance cannot be performed because the road width is narrow. In this case, the avoidance is performed only by the deceleration, however, in order to completely reduce the risk to zero, a significant deceleration may occur, and the driver may feel troublesome. Conversely, if the same avoidance control is always performed, the driver may feel anxious depending on the situation.

The present disclosure has been made in view of the above problems, and an object thereof is to provide a driver assistance system, a driver assistance method, and a computer readable storage medium storing a driver assistance program capable of reducing a collision risk caused by a target in front of a vehicle while suppressing troublesomeness and anxiety given to a driver.

A driver assistance system according to the present disclosure comprises at least one memory storing at least one program, and at least one processor coupled to the at least one memory. The at least one program is configured to cause the at least one processor to execute the following first to fourth processes. The first process is a process of extracting, from information relating to a peripheral situation of the vehicle, risk target information relating to a risk target that is an existence causing a collision risk to the vehicle. The second process is a process of obtaining influence factor information relating to an influence factor that is a factor existing separately from the risk target and influencing the collision risk. The third process is a process of determining a risk value obtained by quantifying the collision risk based on the risk target information and the influence factor information. The fourth process is a process of determining, based on the risk value, a manipulated variable of an actuator for controlling movement of the vehicle so as to decrease the collision risk.

According to the driver assistance system configured as described above, the risk value obtained by quantifying the collision risk is determined based on the risk target information and the influence factor information, and the manipulated variable of the actuator is determined based on the risk value so as to reduce the collision risk. The risk target information is information relating to the risk target that causes the collision risk in the vehicle. The influence factor information is information relating to the influence factor that exists separately from the risk target and influences the collision risk. By determining the risk value by adding the influence factor information to the risk target information, it is possible to appropriately intervene in the actuator operation performed for reducing the collision risk.

As a first aspect of the driver assistance system according to the present disclosure, the at least one program may be configured to cause the at least one processor to execute extracting, as the risk target information, information relating to a potential risk target that exists in front of the vehicle and creates a blind spot from the vehicle. In the first aspect, information relating to a peripheral environment of the potential risk target may be obtained as the influence factor information. Alternatively, in the first aspect, information relating to a moving object behind the potential risk target may be obtained as the influence factor information. Alternatively, in the first aspect, information relating to a dynamic factor acting on the blind spot formed by the potential risk target may be obtained as the influence factor information. Alternatively, in the first aspect, information relating to a time and place at which the potential risk target is detected may be obtained as the influence factor information.

As a second aspect of the driver assistance system according to the present disclosure, the at least one program may be configured to cause the at least one processor to execute extracting, as the risk target information, information relating to an explicit risk target that exists in front of the vehicle and has a possibility of colliding with the vehicle. In the second aspect, if the explicit risk target is a parked vehicle, information relating to presence or absence of a driver in the parked vehicle may be obtained as the influence factor information. Alternatively, in the second aspect, information relating to a state of a road on which the explicit risk target is detected may be obtained as the influence factor information. Alternatively, in the second aspect, information relating to a time and place at which the explicit risk target is detected may be obtained as the influence factor information.

The driver assistance method according to the present disclosure has the following first to fourth steps. The first step is a step of extracting, from information relating to a peripheral situation of the vehicle, risk target information relating to a risk target that is an existence causing a collision risk to the vehicle. The second step is a step of obtaining influence factor information relating to an influence factor that is a factor existing separately from the risk target and influencing the collision risk. The third step is a step of determining a risk value obtained by quantifying the collision risk based on the risk target information and the influence factor information. Then, the fourth step is a step of determining, based on the risk value, a manipulated variable of an actuator for controlling movement of the vehicle so as to decrease the collision risk.

The computer readable storage medium according to the present disclosure stores a program configured to cause a processor to execute processing, the processing comprising the following first to fourth processes. The first process is a process of extracting, from information relating to a peripheral situation of a vehicle, risk target information relating to a risk target that is an existence causing a collision risk to the vehicle. The second process is a process of obtaining influence factor information relating to an influence factor that is a factor existing separately from the risk target and influencing the collision risk. The third process is a process of determining a risk value obtained by quantifying the collision risk based on the risk target information and the influence factor information. Then, the fourth process is a process of determining, based on the risk value, a manipulated variable of an actuator for controlling movement of the vehicle so as to decrease the collision risk.

According to the driver assistance system, the driver assistance method, and the computer readable storage medium of the present disclosure, by determining the risk value by adding the influence factor information to the risk target information, it is possible to appropriately intervene in the actuator operation performed for reducing the collision risk. This reduces the collision risk caused by the target in front of the vehicle while suppressing the troublesome or anxious feeling given to the driver.

### BRIEF DESCRIPTION OF THE DRAWINGS

FIG. 1 is a conceptual diagram for explaining an outline of a potential risk avoidance control in the driver assistance control by the driver assistance system according to an embodiment of the present disclosure.

FIG. 2 is a conceptual diagram for explaining an outline of the potential risk avoidance control in the driver assistance control by the driver assistance system according to the embodiment of the present disclosure.

FIG. 3 is a conceptual diagram for explaining an outline of the explicit risk avoidance control in the driver assistance control by the driver assistance system according to the embodiment of the present disclosure.

FIG. 4 is a conceptual diagram for explaining an outline of the explicit risk avoidance control in the driver assistance control by the driver assistance system according to the embodiment of the present disclosure.

FIG. 5 is a block diagram showing an example of a configuration of a driver assistance system according to the embodiment of the present disclosure and a vehicle to which the driver assistance system is applied.

FIG. 6 is a block diagram illustrating processing performed by a processor according to the embodiment of the present disclosure.

FIG. 7 is a conceptual diagram for explaining a first example of driver assistance control by the driver assistance system according to the embodiment of the present disclosure.

FIG. 8 is a conceptual diagram for explaining the first example of driver assistance control by the driver assistance system according to the embodiment of the present disclosure.

FIG. 9 is a conceptual diagram for explaining a second example of the driver assistance control by the driver assistance system according to the embodiment of the present disclosure.

FIG. 10 is a conceptual diagram for explaining the second example of the driver assistance control by the driver assistance system according to the embodiment of the present disclosure.

FIG. 11 is a conceptual diagram for explaining a third example of the driver assistance control by the driver assistance system according to the embodiment of the present disclosure.

FIG. 12 is a conceptual diagram for explaining the third example of the driver assistance control by the driver assistance system according to the embodiment of the present disclosure.

FIG. 13 is a conceptual diagram for explaining a fourth example of the driver assistance control by the driver assistance system according to the embodiment of the present disclosure.

FIG. 14 is a conceptual diagram for explaining the fourth example of the driver assistance control by the driver assistance system according to the embodiment of the present disclosure.

FIG. 15 is a conceptual diagram for explaining a fifth example of the driver assistance control by the driver assistance system according to the embodiment of the present disclosure.

FIG. 16 is a conceptual diagram for explaining the fifth example of the driver assistance control by the driver assistance system according to the embodiment of the present disclosure.

FIG. 17 is a conceptual diagram for explaining the fifth example of the driver assistance control by the driver assistance system according to the embodiment of the present disclosure.

FIG. 18 is a conceptual diagram for explaining a sixth example of the driver assistance control by the driver assistance system according to the embodiment of the present disclosure.

FIG. 19 is a conceptual diagram for explaining the sixth example of the driver assistance control by the driver assistance system according to the embodiment of the present disclosure.

FIG. 20 is a conceptual diagram for explaining a seventh example of the driver assistance control by the driver assistance system according to the embodiment of the present disclosure.

FIG. 21 is a conceptual diagram for explaining the seventh example of the driver assistance control by the driver assistance system according to the embodiment of the present disclosure.

FIG. 22 is a conceptual diagram for explaining the seventh example of the driver assistance control by the driver assistance system according to the embodiment of the present disclosure.

### DETAILED DESCRIPTION

Hereunder, embodiments of the present disclosure will be described with reference to the drawings. Note that when the numerals of numbers, quantities, amounts, ranges and the like of respective elements are mentioned in the embodiments shown as follows, the present disclosure is not limited to the mentioned numerals unless specially explicitly described otherwise, or unless the disclosure is explicitly designated by the numerals theoretically. Furthermore, structures and steps that are described in the embodiments shown as follows are not always indispensable to the disclosure unless specially explicitly shown otherwise, or unless the disclosure is explicitly designated by the structures or the steps theoretically.

### 1. Outline of Driver Assistance System According to Embodiment

### 1-1. Outline of Driver Assistance Control

The driver assistance system according to the present embodiment executes a driver assistance control to assist the driving of the vehicle so as to avoid the risk that the vehicle collides with the object in front thereof. The collision risk that the vehicle should avoid includes a potential risk and an explicit risk. The potential risk is a collision risk potentially present in a blind spot from the vehicle. The explicit risk is a collision risk explicitly present, such as a pedestrian who may run out ono the road. The driver assistance system according to the present embodiment avoids both of these two types of collision risks.

In the driver assistance control, a risk value obtained by quantifying the collision risk is used. The risk value is given as a distribution on a vehicle coordinate system or an absolute coordinate system. The distribution of this risk value is defined as a risk potential field. Typically, the risk value is defined according to information relating to a target object to be avoided from a collision, such as the position of the target object, the distance from the target object, the type of the target object, the size of the target object, the displacement speed of the target object, etc. Note that coordinate transformation can be performed between the vehicle coordinate system and the absolute coordinate system.

If the collision risk is a potential risk, the target object is a virtual object that is hidden in a blind spot of a target that causes the potential risk (hereinafter, this target is referred to as a potential risk target). In this case, virtual information linked to the potential risk target is given as information relating to the target object for defining the risk value. Therefore, if the collision risk is a potential risk, the distribution of the risk value is linked to the potential risk target. On the other hand, when the collision risk is an explicit risk, the target object is a target itself that causes the explicit risk (hereinafter, this target is referred to as an explicit risk target). In this case, the risk value is determined based on information relating to the explicit risk target, and the distribution of the risk value is linked to the explicit risk target.

As described above, the risk value relating to the driver assistance control is determined based on the information relating to the potential risk target or the explicit risk target. Hereinafter, this information is referred to as risk target information. The risk target information is information relating to a risk target that is an existence that causes a collision risk in the vehicle, and is extracted from peripheral situation information obtained by an autonomous sensor mounted on the vehicle. However, in the driver assistance system according to the present embodiment, the information used for determining the risk value is not only the risk target information.

The driver assistance system according to the present embodiment uses information relating to a factor existing separately from the risk target and influencing the collision risk to determine the risk value. The collision risk is not determined by the risk target itself, but is influenced by various factors surrounding it. Hereinafter, a factor influencing the collision risk is referred to as an influence factor, and information relating to the influence factor is referred to as influence factor information. It can also be said that the risk target information is information for determining a basic value of the risk value, and the influence factor information is information for providing a correction term or a correction coefficient for correcting the basic value.

In the driver assistance control, vehicle control is performed to operate the vehicle so as to avoid the collision risk. The vehicle control for risk avoidance includes at least one of a braking control for braking the vehicle by operating a braking actuator and a steering control for steering the vehicle by operating a steering actuator. The risk value described above, and more particularly the risk potential field, which is the distribution of the risk value, is used to determine a manipulated variable of each actuator.

Hereinafter, the driver assistance control performed for avoiding the potential risk is referred to as potential risk avoidance control, and the driver assistance control performed for avoiding the explicit risk is referred to as explicit risk avoidance control. The next chapter provides a more detailed description of each of potential risk avoidance control and explicit risk avoidance control.

### 1-2. Potential Risk Avoidance Control

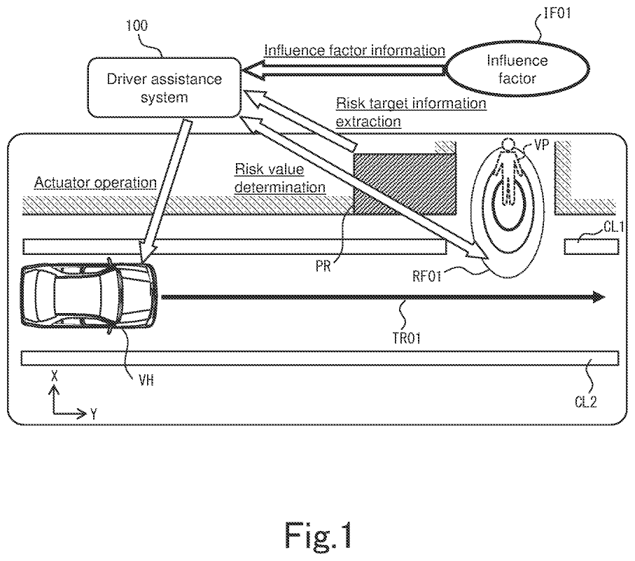

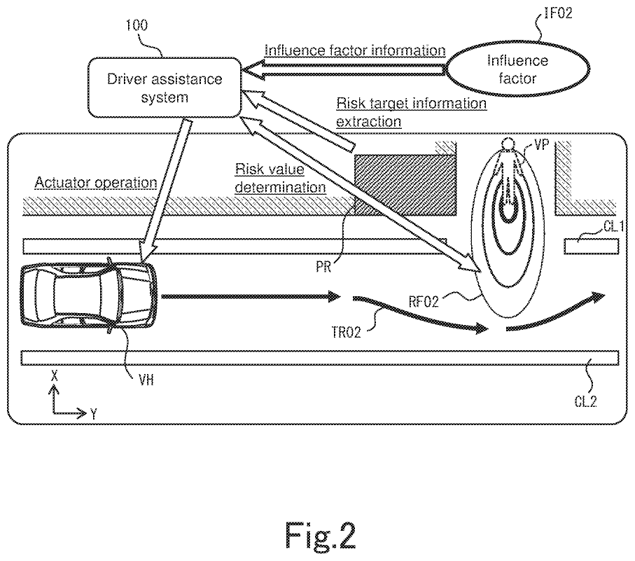

FIGS. 1 and 2 are conceptual diagrams for explaining an outline of the potential risk avoidance control by a driver assistance system 100 according to the present embodiment. In FIGS. 1 and 2, it is depicted that a vehicle VH is traveling in a traveling lane defined by two compartment lines CL1 and CL2. A sideway is connected to the right side of the traveling lane. The presence of the sideway can be obtained from map information. A building is recognized as a potential risk target PR in front of the sideway. The potential risk target PR is defined as a target that is in front of the vehicle VH and creates a blind spot from the vehicle VH. The blind spot from the vehicle VH means, more specifically, the blind spot for the autonomous sensor mounted on the vehicle VH. The potential risk target PR itself can be recognized by the autonomous sensor.

The potential risk target PR creates a blind spot on the sideway that is invisible to the vehicle VH. In the potential risk avoidance control, it is assumed that a virtual pedestrian VP exists behind the potential risk target PR. Then, a risk potential field RF01, RF02 spreading around the virtual pedestrian VP is generated. The risk potential field RF01, RF02 can be represented by contour lines connecting sets of points having the same magnitude of risk value, as shown in FIGS. 1 and 2, for example. In this example, a contour line closer to the center has a larger risk value, and an outer contour line has a smaller risk value. The risk potential fields RF01 and RF02 shown in FIG. 1 and FIG. 2 indicate areas in which the risk value is equal to or larger than a predetermined value. The risk value equal to or larger than the predetermined value is a risk value having a magnitude to be avoided by the vehicle VH. This is common to the other figures used in the present application. Areas having a magnitude equal to or larger than the predetermined risk value are illustrated as the risk potential fields by contour lines.

The risk values of the respective positions forming the risk potential field RF01, RF02 are determined by the driver assistance systems 100. In the case of the potential risk avoidance control, the driver assistance system 100 extracts the risk target information relating to the potential risk target PR from the peripheral situation information of the vehicle VH obtained by the autonomous sensor, and obtains the influence factor information relating to the influence factor IF01, IF02. Other examples of the potential risk target PR include a block wall at an intersection or at a corner of a T-shaped road, a wall, a parked vehicle in a roadside zone, and the like. Specific examples of influence factors will be described in the examples of the potential risk avoidance control described later.

The driver assistance system 100 determines the risk value based on the risk target information and the influence factor information. The distribution of the determined risk value is the risk potential field RF01, RF02. FIGS. 1 and 2 show the distributions in the vehicle coordinate system where the traveling direction of the vehicle VH is shown as the Y-axis and the lateral direction of the vehicle VH is shown as the X-axis. This is also common in other figures used in this application.

When the potential risk targets PR are the same, there is no difference in the risk target information, and therefore, a difference between influence factors IF01 and IF02 causes a difference in the magnitude between the risk potential fields RF01 and RF02. For example, the risk potential field RF02 shown in FIG. 2 is wider than the risk potential field RF01 shown in FIG. 1. This is because the influence factor IF02 in FIG. 2 has a larger influence on the collision risk than the influence factor IF01 in FIG. 1.

The driver assistance system 100 generates a target trajectory TR01, TR02 of the vehicle VH based on the risk potential field RF01, RF02. The target trajectory TR01, TR02 is a trajectory on which the vehicle VH travels in the target route, and includes a set of target points of the vehicle VH in the vehicle coordinate system, and a target speed at each target point. Typically, the target trajectory TR01, TR02 is generated so that the vehicle VH travels in the center of the traveling lane according to the legal speed. In the example shown in FIG. 1, since the risk potential field RF01 is narrow, the target trajectory TR01 can be drawn so as not to interfere with the risk potential field RF01. In the example shown in FIG. 2, the risk potential field RF02 spreads toward the lane in which the vehicle VH travels. Therefore, in the example shown in FIG. 2, the target trajectory TR02 that bypasses the risk potential field RF02 is generated.

The driver assistance system 100 determines the manipulated variables of the respective actuators so that the vehicle VH follows the target trajectory TR01, TR02. Since the target trajectory TR01, TR02 is generated based on the risk potential field RF01, RF02, following the vehicle VH to the target trajectory TR01, TR02 means that the manipulated variables of the respective actuators are determined so as to reduce the collision risk caused by the potential risk target PR.

According to the potential risk avoidance control as described above, by determining the risk potential field RF01, RF02 by adding the influence factor information to the risk target information, it is possible to make the interventions to the actuator operations performed for the reduction of the collision risk appropriate. As a result, it is possible to reduce the collision risk caused by the potential risk target PR in front of the vehicle VH while suppressing the troublesomeness and anxiety given to the driver.

### 1-3. Explicit Risk Avoidance Control

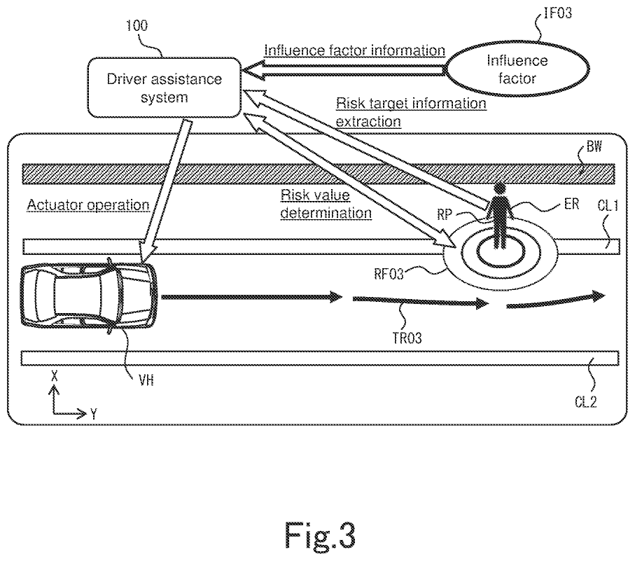

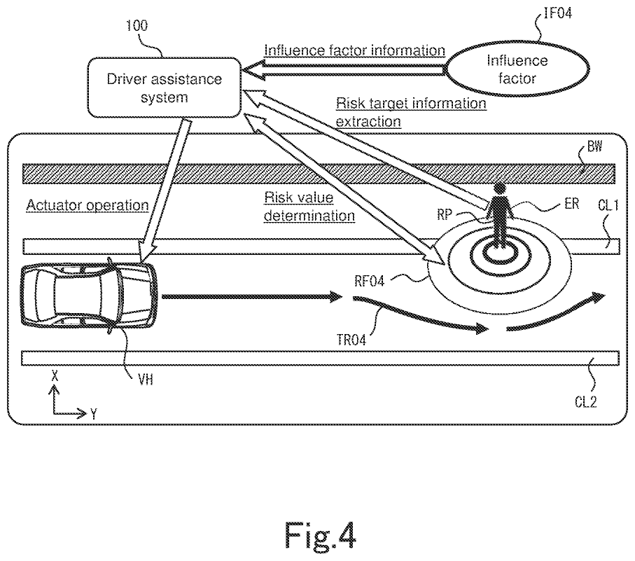

FIGS. 3 and 4 are conceptual diagrams for explaining an outline of the explicit risk avoidance control by the driver assistance system 100 according to the present embodiment. In FIGS. 3 and 4, it is depicted that a vehicle VH is traveling in a traveling lane defined by two compartment lines CL1 and CL2. The area between the left compartment line CL1 and the outer block wall BW is a roadside zone. In FIGS. 3 and 4, a pedestrian RP is recognized as an explicit risk target ER walking near the compartment line CL1 in the roadside zone. This pedestrian RP is not a virtual pedestrian but a real pedestrian recognized by the autonomous sensor.

A risk potential field RF03, RF04 spreading around the explicit risk target ER is generated around the explicit risk target ER. In the risk potential field RF03, RF04 generated by the explicit risk target ER, the risk value increases as the contour line is closer to the center, and the risk value decreases as the contour line is closer to the outer side.

The risk values of the respective positions forming the risk potential field RF03, RF04 are determined by the driver assistance systems 100. In the explicit risk avoidance control, the driver assistance system 100 extracts the risk target information relating to the explicit risk target ER from the peripheral situation information of the vehicle VH obtained by the autonomous sensor, and obtains the influence factor information relating to the influence factor IF03, IF04. Other examples of the explicit risk target ER include a bicycle, a two-wheeled vehicle, a parked vehicle, and the like in a roadside zone. Still other examples of the explicit risk target ER include a bicycle, a two-wheeled vehicle, a preceding vehicle, and the like in the traveling lane. Specific examples of influence factors relating to the explicit risk target ER will be described in the examples of the explicit risk avoidance control described later.

The driver assistance system 100 determines a risk value based on the risk target information and the influence factor information. The distribution of the determined risk value is the risk potential field RF03, RF04. When the explicit risk targets ER are the same, there is no difference in the risk target information, and therefore, a difference between influence factors IF03 and IF04 causes a difference in the magnitude between the risk potential fields RF03 and RF04. For example, the risk potential field RF04 shown in FIG. 4 is wider than the risk potential field RF03 shown in FIG. 3. This is because the influence factor IF04 in FIG. 4 has a larger influence on the collision risk than the influence factor IF03 in FIG. 1.

The driver assistance system 100 generates a target trajectory TR03, TR04 of the vehicle VH based on the risk potential field RF03, RF04. In the example shown in FIG. 3, since the risk potential field RF03 is narrow, in order to prevent the target trajectory TR03 from interfering with the risk potential field RF03, the target trajectory TR03 may be slightly spread rightward. In the example shown in FIG. 4, the risk potential field RF04 spreads greatly to the middle of the lane in which the vehicle VH travels. For this reason, in the example shown in FIG. 4, the target trajectory TR04 that largely bypasses the risk potential field RF04 to the right is generated.

The driver assistance system 100 determines the manipulated variables of the respective actuators so that the vehicle VH follows the target trajectory TR03, TR04. Since the target trajectory TR03, TR04 is generated based on the risk potential field RF03, RF04, following the vehicle VH to the target trajectory TR03, TR04 means that the manipulated variables of the respective actuators are determined so as to reduce the collision risk caused by the explicit risk target ER.

According to the explicit risk avoidance control as described above, by determining the risk potential field RF03, RF04 by adding the influence factor information to the risk target information, it is possible to appropriately intervene in the actuator operation to reduce the collision risk. As a result, it is possible to reduce the collision risk caused by the explicit risk target ER in front of the vehicle VH while suppressing the troublesomeness and anxiety given to the driver.

### 2. Configuration and Function of Driver Assistance System According to Present Embodiment

### 2-1. Configuration of Driver Assistance System

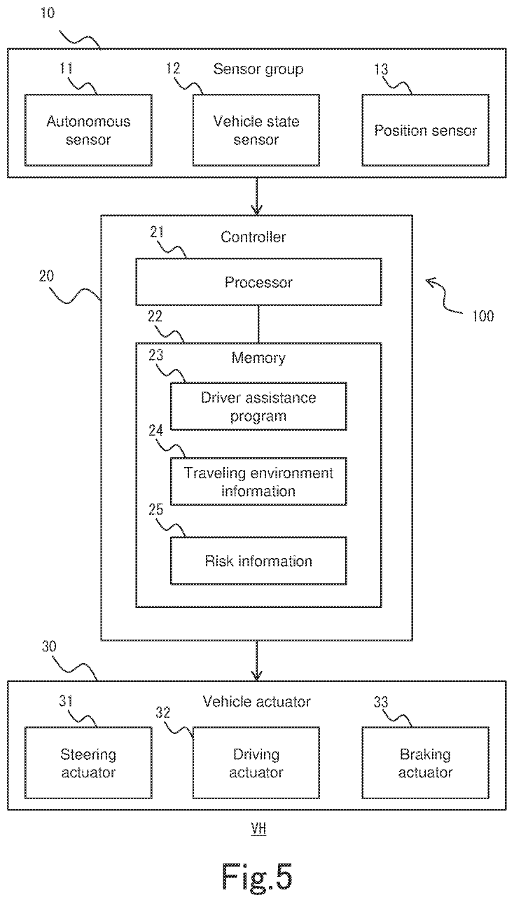

FIG. 5 is a diagram showing a configuration example of the driver assistance system 100 and the vehicle VH to which the driver assistance system 100 is applied according to the present embodiment. The vehicle VH includes a controller 20 for controlling the vehicle VH, a sensor group 10 for inputting information to the controller 20, and a vehicle actuator 30 operated by a signal output from the controller 20. The controller 20, the sensor group 10 and the vehicle actuator 30 are connected by an in-vehicle network. The driver assistance system 100 includes at least the controller 20. However, the driver assistance system 100 may include the sensor group 10 in addition to the controller 20. The driver assistance system 100 may also include the vehicle actuator 30.

The sensor group 10 includes an autonomous sensor 11, a vehicle state sensor 12, and a position sensor 13. The autonomous sensor 11 is a sensor that obtains information relating to peripheral situation of the vehicle including the area in front of the vehicle VH. The autonomous sensor 11 includes at least one of, for example, a camera, a millimeter-wave radar, and a LiDAR (Laser Imaging Detection and Ranging). Based on the information obtained by the autonomous sensor 11, processing such as detection of an object around the vehicle VH, measurement of the relative position and relative speed of the detected object to the vehicle VH, and recognition of the shape of the detected object is performed. The vehicle state sensor 12 is a sensor that obtains information relating to the motion of the vehicle VH. The vehicle state sensor 12 includes at least one of, for example, a wheel speed sensor, an acceleration sensor, a yaw rate sensor, and a steering angle sensor. The position sensor 13 is used to obtain information relating to the current position of the vehicle VH. An example of the position sensor 13 is a GPS (Global Positioning System) receiver.

The vehicle actuator 30 is an actuator that controls the motion of the vehicle VH. The vehicle actuator 30 includes a steering actuator 31 for steering the vehicle VH, a driving actuator 32 for driving the vehicle VH, and a braking actuator 33 for braking the vehicle VH. The steering actuator 31 includes, for example, a power steering system, a steer-by-wire steering system, and a rear wheel steering system. A driving actuator 32 includes, for example, an engine, an EV system, and a hybrid system. A braking actuator 33 includes, for example, a hydraulic brake and a power regenerative brake.

The controller 20 is an ECU (Electronic Control Unit) mounted on the vehicle VH or an assembly of a plurality of ECUs. Alternatively, the controller 20 may have some or all of its functions located on an external server. In this case, the vehicle VH and the server are connected by a mobile communication network. In any case, the controller 20 comprises at least one processor 21 and at least one memory 22. The memory 22 includes a main storage device and an auxiliary storage device. The memory 22 stores a program executable by the processor 21 and various related information. The program includes a driver assistance program 23 for causing the processor 21 to execute the driver assistance control described above. The driver assistance program 23 may be stored in the main memory or may be stored in a computer readable storage medium which is the auxiliary storage device. The information stored in the memory 22 includes traveling environment information 24 and risk information 25.

### 2-2. Information Stored in Memory

The traveling environment information 24 is information indicating the traveling environment of the vehicle VH. The traveling environment information 24 includes, for example, vehicle position information, vehicle state information, and map information. The vehicle position information is information indicating a position and orientation of the vehicle VH obtained from a detection result by the position sensor 13. The vehicle state information is information such as vehicle speed, yaw rate, lateral acceleration, steering angle obtained from a detection result by the vehicle state sensor 12. The map information includes, for example, a lane arrangement and a road shape. The controller 20 obtains the map information of a necessary area from a map database. The map database may be stored in a predetermined memory installed in the vehicle VH, or may be obtained from a server outside the vehicle VH.

The traveling environment information 24 further includes peripheral situation information indicating a peripheral situation of the vehicle VH. The peripheral situation information includes information obtained by the autonomous sensor 11, for example, image information indicating the peripheral situation of the vehicle VH captured by the camera, and measurement information measured by the millimeter-wave radar or LiDAR.

The peripheral situation information further includes road structure information. The road structure information is information relating to a relative position of the road structure around the vehicle VH with respect to the vehicle VH. The road structure around the vehicle VH includes a compartment line and a road edge object. The road edge object is a three-dimensional object indicating the edge of a road, and includes, for example, a curb, a guardrail, a wall, and a central separation zone. The relative positions of these road structures can be obtained, for example, by analyzing image information obtained by the camera.

The peripheral situation information further includes target information. The target information is information relating to a target around the vehicle VH. The target information includes a relative position and a relative speed of the target with respect to the vehicle VH. For example, analyzing image information obtained by a camera makes it possible to identify the target and calculate a relative position thereof. Also, radar measurement information makes it possible to identify the target and obtain a relative position and a relative speed of the target. The target information includes the size and type of the recognized target. The target information may include a moving direction and a moving speed of the target. In addition, the target information may include a history of a relative position, a relative speed, a moving direction, and a movement speed of the target during a past period of time. The target includes the above-mentioned potential risk target and the above-mentioned explicit risk target, and the target information includes the above-mentioned risk target information.

The traveling environment information 24 further includes influence factor information. The influence factor information is information relating to an influence factor influencing the collision risk of the vehicle VH. There are two types of influence factor information. One is information relating to an influence factor influencing the collision risk arising from the potential risk target. Another is information relating to an influence factor influencing the collision risk arising from the explicit risk target. Examples of the former include information relating to a peripheral environment of the potential risk target, information relating to a moving object behind the potential risk target, information relating to a dynamic factor acting on a blind spot created by the potential risk target, and information relating to a time and space at which the potential risk target is detected. Examples of the latter include information relating to presence or absence of a driver in a parked vehicle when the explicit risk target is a parked vehicle, information relating to a state of a road on which the explicit risk target is detected, and information relating to a time and place at which the explicit risk target is detected. The influence factor information is stored in association with the risk target information.

The risk information 25 is information relating to a risk potential field on a road on which the vehicle VH travels. A distribution of risk values in a vehicle coordinate system or an absolute coordinate system is stored as the risk information 25. The risk value is calculated by the processor 21 based on the risk target information and the influence factor information.

### 2-3. Processing Performed by Processor

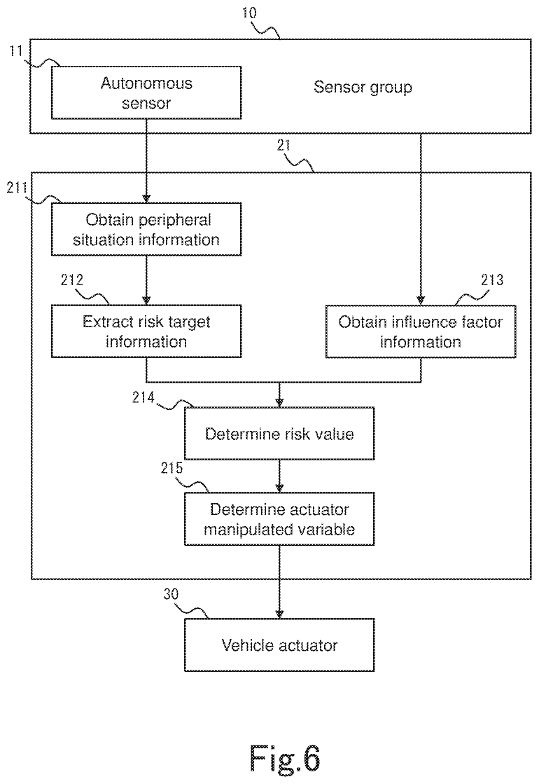

FIG. 6 is a block diagram showing processing executed by the processor 21 when the driver assistance program 23 is executed. By executing the driver assistance program 23, the processor 21 executes processes 211, 212, 213, 214, and 215.

First, the processor 21 executes the process 211. In the process 211, the peripheral situation information is obtained from the autonomous sensor 11. Strictly speaking, the peripheral situation information detected by the autonomous sensor 11 is temporarily stored in the memory 22, and the temporarily stored peripheral situation information is read out to the processor 21.

The processor 21 then executes the process 212. In the process 212, the risk target information relating to the risk target which is an existence causing the collision risk is extracted from the target information included in the peripheral situation information. Whether or not the target in front of the vehicle VH is the risk target is determined from the relative position, the relative speed, the size, the type, and the like of the target. For all the risk target in front of the vehicle VH, the risk target information is extracted from the peripheral situation information.

The processor 21 executes the process 213 in parallel with the process 212. In step 213, the influence factor information relating to the recognized risk target is obtained from the sensor group 10. The influence factor influencing the collision risk differs depending on the type of the risk target that causes the collision risk. For each recognized risk target, the processor 21 obtains influence factor information from the sensor group 10 for all the influence factors influencing the collision risk arising from the risk target.

After executing the process 212 and the process 213, the processor 21 executes the process 214. The process 214 determines a risk value obtained by quantifying the collision risk based on the risk target information and the influence factor information. The processor 21 calculates a basic distribution of the risk value based on the risk target information. If the risk target information is the same, the basic distribution of the risk value is constant, and the shape of the risk potential field represented by contour lines is also constant. Next, the processor 21 corrects the distribution of the risk value from the basic distribution based on the influence factor information. For example, if the influence factor influences the collision risk to increase it, the processor 21 corrects the distribution of the risk value to increase the risk value at each position with respect to the basic distribution of the risk value. Also, for example, if the influence factor influences the collision risk in the lateral direction to increase it, the processor 21 corrects the distribution of the risk value to increase the risk value to the lateral direction with respect to the basic distribution of the risk value.

After execution of the process 214, the processor 21 executes the process 215. The process 215 determines actuator manipulated variables based on the distribution of the risk value determined in the process 214. Specifically, a target trajectory with a small collision risk is generated based on the distribution of the risk value, and actuator manipulated variables for making the vehicle VH follow the target trajectory is determined. The processor 21 operates the vehicle actuator 30 in accordance with the actuator manipulated variables determined in the process 215. Steering of the vehicle VH is controlled by the operation of the steering actuator 31 by the processor 21. Driving of the vehicle VH is controlled by the operation of the driving actuator 32 by the processor 21. Braking of the vehicle VH is controlled by the operation of the braking actuator 33 by the processor 21.

### 3. Example of Driver Assistance Control

### 3-1. Example 1

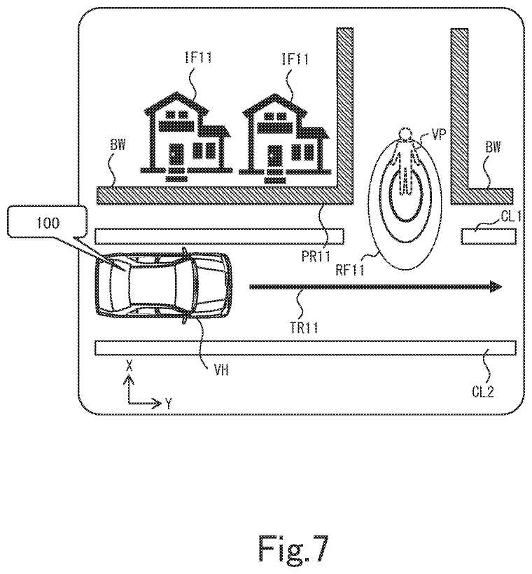

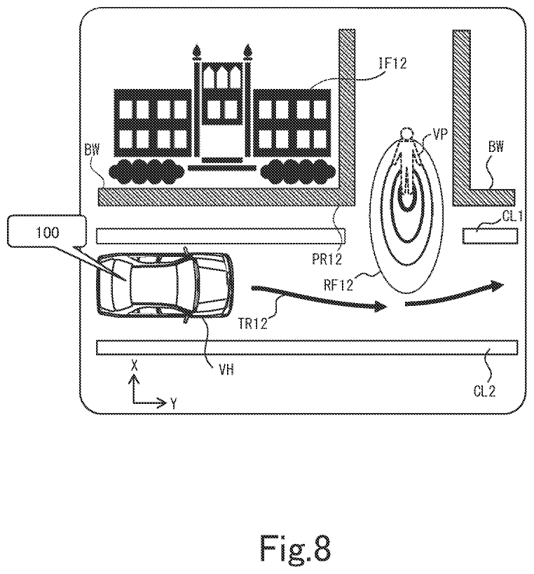

FIGS. 7 and 8 are conceptual diagrams for explaining a first example of the driver assistance control by the driver assistance system 100. The first example of the driver assistance control is an example of the potential risk avoidance control. In the first example, a sideway is connected to the right side of a traveling lane defined by two compartment lines CL1 and CL2. A block wall BW is installed on the right side of the traveling lane and on both sides of the sideway. Therefore, when viewed from a vehicle VH traveling in the traveling lane, the corner portion where the sideway is connected to the traveling lane is blind by the block wall BW. The driver assistance system 100 recognizes the block wall BW, which is in front of the vehicle VH and creates a blind spot from the vehicle VH, as a potential risk target PR11, PR12.

In the potential risk avoidance control, it is assumed that a virtual pedestrian VP exists in the blind spot of the potential risk target PR11, PR12. The driver assistance system 100 extracts risk target information relating to the virtual pedestrian VP from peripheral situation information, and obtains influence factor information relating to the virtual pedestrian VP. The risk target information is target information relating to the block wall BW, which is the potential risk target PR11, PR12, and is common to the example shown in FIG. 7 and the example shown in FIG. 8. On the other hand, the influence factor information differs between the example shown in FIG. 7 and the example shown in FIG. 8.

In the first example, the driver assistance system 100 obtains information relating to the peripheral environment of the block wall BW, which is the potential risk target PR11, PR12, as influence factor information. The peripheral environment around the potential risk target refers to, for example, a school, a park, a shopping area, a residential area, a factory area, a vacant area, and the like. In the example shown in FIG. 7, the influence factor IF11 influencing the collision risk is a residential area around the potential risk target PR11. In the example shown in FIG. 8, the influence factor IF12 influencing the collision risk is a school around the potential risk target PR12. There is a high risk of children jumping out around the school. Therefore, the influence factor IF12 is greater in the influence on the collision risk than the influence factor IF11.

In the example shown in FIG. 7, information relating to the residential area as the influence factor IF11 is obtained as the influence factor information. In the example shown in FIG. 8, information relating to the school as the influence factor IF12 is obtained as the influence factor information. Since the influence factor information is information relating to the peripheral environment of the potential risk target PR11, PR12, the influence factor information can be obtained based on, for example, map information and vehicle position information.

The driver assistance system 100 generates a risk potential field RF11, RF12 spreading around the virtual pedestrian VP based on the risk target information and the influence factor information relating to the virtual pedestrian VP. As described above, the influence of the influence factor IF12, which is the school, on the collision risk is greater than the influence of the influence factor IF11, which is the residential area, on the collision risk. Further, since the collision risk assumed in the first example is a risk caused by the virtual pedestrian VP jumping out of the sideway, the distribution of the risk value spreads to the jumping-out destination as the collision risk increases.

In the first example, the driver assistance system 100 sets the risk potential field RF11, RF12 to an ellipse extending from the sideway toward the traveling lane. In the example shown in FIG. 8 where the risk of the virtual pedestrian VP jumping out is higher, the driver assistance system 100 spreads the risk potential field RF12 greater from the sideway to the traveling lane than the risk potential field RF11 in the example shown in FIG. 7.

The driver assistance system 100 generates a target trajectory TR11, TR12 of the vehicle VH based on the risk potential field RF11, RF12. In the example shown in FIG. 7, the target trajectory TR11 is drawn along the center of the traveling lane so as not to interfere with the risk potential field RF11. The driver assistance system 100 determines the manipulated variables of the respective actuators so that the vehicle VH follows the target trajectory TR11. In the example shown in FIG. 8, the target trajectory TR12 is generated so as to bypass the risk potential field RF12 spreading to the vicinity of the center of the traveling lane. The driver assistance system 100 determines the manipulated variables of the respective actuators so that the vehicle VH follows the target trajectory TR12.

### 3-2. Example 2

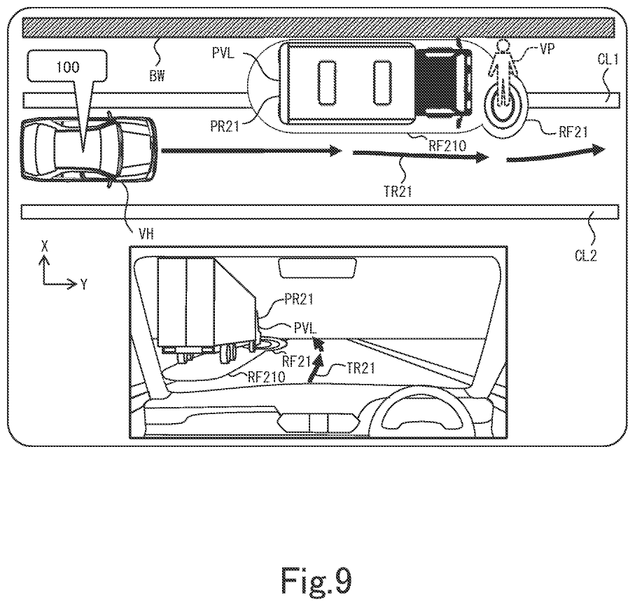

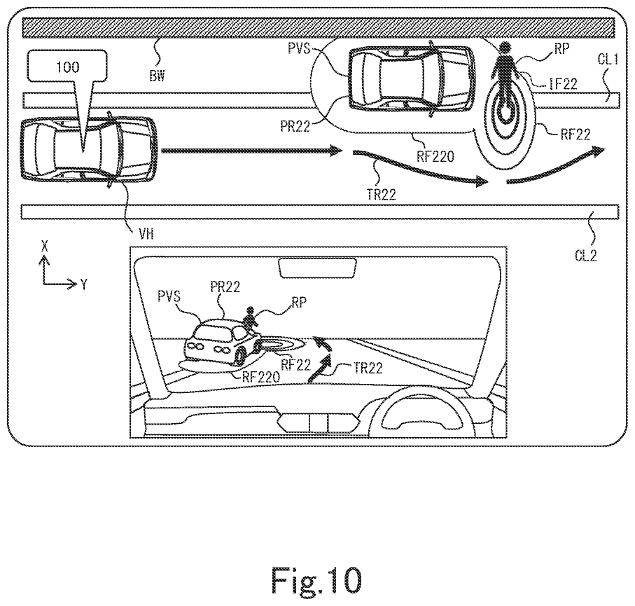

FIGS. 9 and 10 are conceptual diagrams for explaining a second example of the driver assistance control by the driver assistance system 100. The second example of the driver assistance control is an example of the potential risk avoidance control. In each of FIGS. 9 and 10, a front view from inside of a vehicle VH is drawn together with a plan view of a traveling lane viewed from above. In the second example, a parked vehicle PVL, PVS is in a roadside zone between a left compartment line CL1 and an outer block wall BW. When viewed from the vehicle VH traveling in the traveling lane, there is a blind spot behind the parked vehicle PVL, PVS. The driver assistance system 100 recognizes the parked vehicle PVL, PVS that is in front of the vehicle VH and creates an area that becomes a blind spot from the vehicle VH as a potential risk target PR21, PR22.

In the potential risk avoidance control, it is assumed that a virtual pedestrian VP exists in a blind spot. In the example shown in FIG. 9, since the parked vehicle PVL is a large vehicle, even if a pedestrian behind the parked vehicle PVL exists actually, the pedestrian will be completely hidden in the blind spot. Therefore, in the example shown in FIG. 9, an assumption that a virtual pedestrian VP exists in the blind spot of the parked vehicle PVL is maintained. On the other hand, in the example shown in FIG. 10, since the parked vehicle PVS is a small vehicle, a pedestrian RP behind the parked vehicle PVS is not completely hidden in the blind spot of the parked vehicle PVS. The driver assistance system 100 can recognize the real pedestrian RP as a target. In the example shown in FIG. 10, the assumption that a virtual pedestrian VP exists in the blind spot of the parked vehicle PVS is replaced by the fact that there is a real pedestrian RP behind the parked vehicle PVS.

In the example shown in FIG. 9, the driver assistance system 100 extracts target information relating to the parked vehicle PVL, which is the potential risk target PR21, from peripheral situation information as risk target information. In the example shown in FIG. 10, the driver assistance system 100 extracts target information relating to the parked vehicle PVS, which is the potential risk target PR22, from peripheral situation information as risk target information. The parked vehicle PVL, PVS is not only a potential risk target for creating a blind spot, but also an explicit risk target.

In the second example, the driver assistance system 100 obtains information relating to a moving object existing behind the potential risk target PR21, PR22 as influence factor information. In the example shown in FIG. 9, since the rear of the parked vehicle PVL, which is the potential risk target PR21, is completely blind, the presence of a moving object is unknown. The driver assistance system 100 obtains, as the influence factor information, the fact that it is unknown whether or not a moving object exists behind the potential risk target PR21. On the other hand, in the example shown in FIG. 10, a real pedestrian RP is recognized behind the parked vehicle PVS, which is the potential risk target PR22. In the example shown in FIG. 10, the influence factor IF22 that influences the collision risk generated by the potential risk target PR22 is the real pedestrian RP. The driver assistance system 100 obtains target information relating to the real pedestrian RP as the influence factor information.

The driver assistance system 100 generates a risk potential field RF21, RF22 based on the risk target information and the influence factor information. In the example shown in FIG. 9, since it is unknown whether a moving object exists behind the potential risk target PR21, the driver assistance system 100 generates the risk potential field RF21 spreading around the virtual pedestrian VP that is assumed to be in the blind spot. In this case, the driver assistance system 100 generates the risk potential field RF21 having a standard size determined from the risk target information of the potential risk target PR21. Since the parked vehicle PVL, which is the potential risk target PR21, is also an explicit risk target, the driver assistance system 100 also generates a risk potential field RF210 spreading around the parked vehicle PVL.

In the example shown in FIG. 10, the driver assistance system 100 generates the risk potential field RF22 spreading around the real pedestrian RP in place of the virtual pedestrian VP. Compared to the risk potential field RF21 set as if there may be a pedestrian, the risk potential field RF22 set to avoid a collision with the real pedestrian RP is made larger. If the target information of the real pedestrian RP includes a moving direction and a moving speed, a direction in which the risk potential field RF22 is enlarged and an enlargement width may be determined based on the moving direction and the moving speed. Since the parked vehicle PVS, which is the potential risk target PR22, is also an explicit risk target, the driver assistance system 100 also generates a risk potential field RF220 spreading around the parked vehicle PVS.

In the example shown in FIG. 9, the driver assistance system 100 generates a target trajectory TR21 of the vehicle VH based on the risk potential field RF21, RF210. More specifically, the target trajectory TR21 is generated so as not to interfere with the risk potential field RF210 set around the parked vehicle PVL and the risk potential field RF21 set around the virtual pedestrian VP. The driver assistance system 100 determines the manipulated variables of the respective actuators so that the vehicle VH follows the target trajectory TR21.

In the example shown in FIG. 10, the driver assistance system 100 generates a target trajectory TR22 of the vehicle VH based on the risk potential field RF22, RF220. Specifically, the target trajectory TR22 is generated so as not to interfere with the risk potential field RF220 set around the parked vehicle PVS and the risk potential field RF22 set around the real pedestrian RP. Since the risk potential field RF22 spreads to the vicinity of the center of the traveling lane, the target trajectory TR22 is generated to bypass this. The driver assistance system 100 determines the manipulated variables of the respective actuators so that the vehicle VH follows the target trajectory TR22.

### 3-3. Example 3

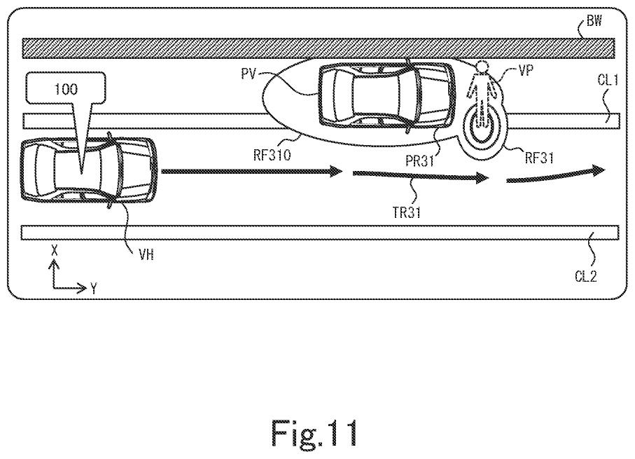

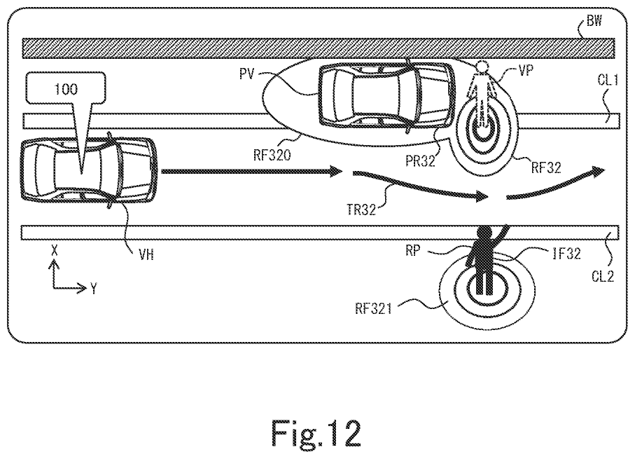

FIGS. 11 and 12 are conceptual diagrams for explaining a third example of the driver assistance control by the driver assistance system 100. The third example of the driver assistance control is an example of the potential risk avoidance control. In the third example, a parked vehicle PV is in a roadside zone between a left compartment line CL1 and an outer block wall BW. When viewed from a vehicle VH traveling in a traveling lane, there is a blind spot behind the parked vehicle PV. The driver assistance system 100 recognizes the parked vehicle PV, which is in front of the vehicle VH and creates a blind spot from the vehicle VH, as a potential risk target PR31, PR32.

In the third example, the driver assistance system 100 extracts target information about the parked vehicle PV, which is the potential risk target PR31, PR32, from peripheral situation information as risk target information. The parked vehicle PV is not only a potential risk target for creating a blind spot, but also an explicit risk target itself.

In the potential risk avoidance control, as shown in FIGS. 11 and 12, it is assumed that a virtual pedestrian VP exists in the blind spot created by the potential risk target PR31, PR32. However, this assumption is based on weak possibility that a pedestrian may possibly be present. However, as in the example shown in FIG. 12, if there is a real pedestrian RP standing on the opposite side of the traveling lane and the real pedestrian RP is giving some signal, such as swinging his/her hand toward the back of the parked vehicle PV, there is a high possibility that there is another person ahead of the person who is giving the signal. In other words, it is highly likely that a pedestrian is in the blind spot created by the potential risk target PR32.

In the third example, the driver assistance system 100 obtains information relating to a dynamic factor acting on the blind spot formed by the potential risk target PR31, PR32 as influence factor information. In the example shown in FIG. 11, since there is nothing around the parked vehicle PV, which is the potential risk target PR31, there is no dynamic factor acting on the blind spot formed by the potential risk target PR31. The driver assistance system 100 obtains, as the influence factor information, that there is no dynamic factor acting on the blind spot formed by the potential risk target PR31. On the other hand, in the example shown in FIG. 12, the real pedestrian RP is recognized as a dynamic factor acting on the blind spot formed by the potential risk target PR31. In the example shown in FIG. 12, the influence factor IF32 that influences the collision risk caused by the potential risk target PR32 is the real pedestrian RP. More specifically, the real pedestrian RP sending a signal toward the blind spot formed by the potential risk target PR31 is the influence factor IF32. The driver assistance system 100 obtains target information relating to the real pedestrian RP as influence factor information.

The driver assistance system 100 generates a risk potential field RF31, RF32 spreading around the virtual pedestrian VP based on the risk target information and the influence factor information. In the example shown in FIG. 11, since there is no dynamic factor acting on the blind spot formed by the potential risk target PR31, the driver assistance system 100 generates the risk potential field RF31 having a standard size determined from the risk target data of the potential risk target PR31. Since the parked vehicle PV, which is the potential risk target PR31, is also an explicit risk target, the driver assistance system 100 also generates a risk potential field RF310 spreading around the parked vehicle PVL.

In the example shown in FIG. 12, the information relating to the real pedestrian RP acting on the blind spot formed by the potential risk target PR32 is used as the influence factor information. Since the real pedestrian RP signals toward the blind spot, there is a high possibility that a pedestrian is actually present in the blind spot. The driver assistance system 100 generates the risk potential field RF32 spreading more largely toward the real pedestrian RP as compared to the risk potential field RF31 that is set as if there may be a pedestrian. Since the parked vehicle PV, which is the potential risk target PR32, is also an explicit risk target, the driver assistance system 100 also generates a risk potential field RF320 spreading around the parked vehicle PV. Furthermore, since the real pedestrian RP itself is also an explicit risk target, the driver assistance system 100 also generates a risk potential field RF321 spreading around the real pedestrian RP.

In the example shown in FIG. 11, the driver assistance system 100 generates a target trajectory TR31 of the vehicle VH based on the risk potential field RF31, RF310. Specifically, in the example shown in FIG. 11, the target trajectory TR31 is generated so as not to interfere with the risk potential field RF310 set around the parked vehicle PV and the risk potential field RF31 set around the virtual pedestrian VP. The driver assistance system 100 determines the manipulated variables of the respective actuators so that the vehicle VH follows the target trajectory TR31.

In the example shown in FIG. 12, the driver assistance system 100 generates a target trajectory TR32 of the vehicle VH based on the risk potential field RF32, RF320, RF321. Specifically, in the example shown in FIG. 12, the target trajectory TR32 is generated so as to pass between the risk potential field RF32 set around the virtual pedestrian VP and the risk potential field RF321 set around the real pedestrian RP. The driver assistance system 100 determines the manipulated variables of the respective actuators so that the vehicle VH follows the target trajectory TR32.

### 3-4. Example 4

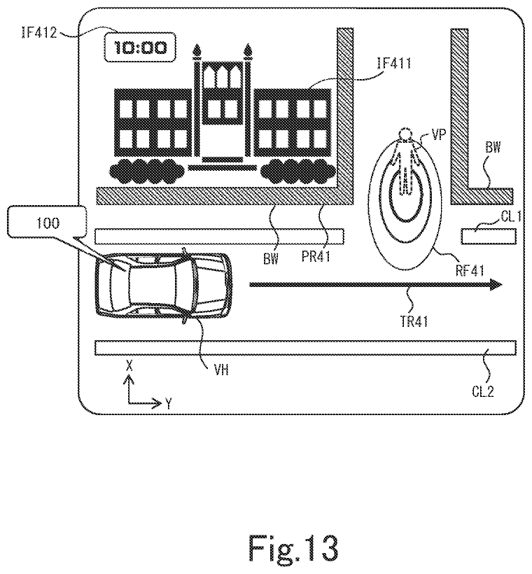

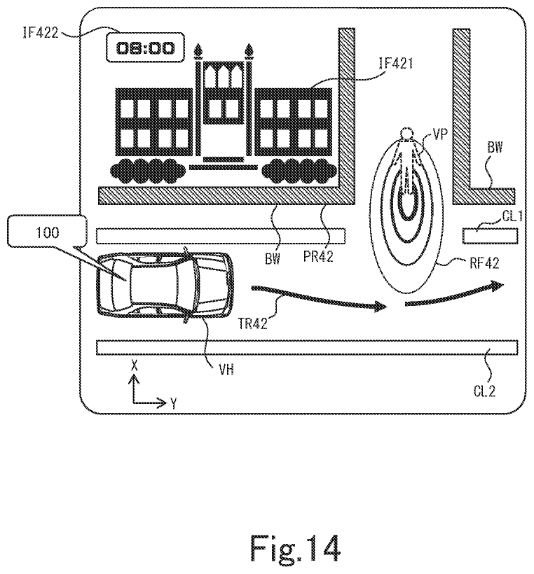

FIGS. 13 and 14 are conceptual diagrams for explaining a fourth example of the driver assistance control by the driver assistance system 100. The fourth example of the driving assistance control is an example of the potential risk avoidance control. In the fourth example, a sideway is connected to the right side of a traveling lane defined by two compartment lines CL1 and CL2. A block wall BW is installed on the right side of the traveling lane and on both sides of the sideway. Therefore, when viewed from a vehicle VH traveling in the traveling lane, the corner portion where the sideway is connected to the traveling lane is blind by the block wall BW. The driver assistance system 100 recognizes the block wall BW, which is in front of the vehicle VH and creates a blind spot from the vehicle VH, as a potential risk target PR41, PR42.

In the potential risk avoidance control, it is assumed that the virtual pedestrian VP exists in the blind spot of the potential risk target object PR41, PR42. The driver assistance system 100 extracts risk target information relating to the virtual pedestrian VP from peripheral situation information, and obtains influence factor information relating to the virtual pedestrian VP. The risk target information is target information relating to the block wall BW, which is the potential risk target PR41, PR42, and is common to the example shown in FIG. 13 and the example shown in FIG. 14. On the other hand, the influence factor information differs between the example shown in FIG. 13 and the example shown in FIG. 14.

In the fourth example, the driver assistance system 100 obtains information relating to a time and place at which the potential risk target PR41, PR42 is detected as influence factor information. The magnitude of the collision risk caused by the potential risk target PR41, PR42 relates to the time and place. More specifically, the combination of the time and place influences the magnitude of the collision risk caused by the potential risk target PR41, PR42.

In the example shown in FIG. 13 and the example shown in FIG. 14, both of the place-influence factors IF411 and IF421 influencing the collision risks are schools. However, the time-influence factors IF412 and IF422 influencing the collision risks differ between the example shown in FIG. 13 and the example shown in FIG. 14. In the example shown in FIG. 13, the time as the influence factor IF412 is 10 o'clock outside school commuting time, whereas in the example shown in FIG. 14, the time as the influence factor IF422 is 8 o'clock within the school commuting time. Because a large number of children are walking around the school within the school commuting time, the risk of children jumping out inevitably increases during commuting time. That is, the example shown in FIG. 14 has a higher risk of jumping out of the virtual pedestrian VP than the example shown in FIG. 13.

The driver assistance system 100 generates a risk potential field RF41, RF42 spreading around the virtual pedestrian VP based on the risk target information and the influence factor information relating to the virtual pedestrian VP. In the example shown in FIG. 13, the fact that the place is the school and the fact that the time is 10 o'clock, which is outside the school commuting time, are obtained as the influence factor information. In the example shown in FIG. 14, the fact that the place is the school and the fact that the time is 8 o'clock, which is within the school commuting time, are obtained as the influence factor information. Of the influence factor information, information relating to the place can be obtained from map information, and information relating to the time can be obtained from a built-in clock of the controller 20.

In the fourth example, the driver assistance system 100 sets the risk potential field RF41, RF42 to an ellipse spreading from the sideway toward the traveling lane. In the example shown in FIG. 14 where the risk of jumping out of the virtual pedestrian VP is higher, the driver assistance system 100 spreads the risk potential field RF42 greater from the sideway to the traveling lane than the risk potential field RF41 in the example shown in FIG. 13.

The driver assistance system 100 generates a target trajectory TR41, TR42 of the vehicle VH based on the risk potential field RF41, RF42. In the example shown in FIG. 13, the target trajectory TR41 is drawn along the center of the traveling lane so as not to interfere with the risk potential field RF41. The driver assistance system 100 determines the manipulated variables of the respective actuators so that the vehicle VH follows the target trajectory TR41. In the example shown in FIG. 14, a target trajectory TR42 is generated to bypass the risk potential field RF42 spreading to the vicinity of the center of the traveling lane. The driver assistance system 100 determines the manipulated variables of the respective actuators so that the vehicle VH follows the target trajectory TR42.

### 3-5. Example 5

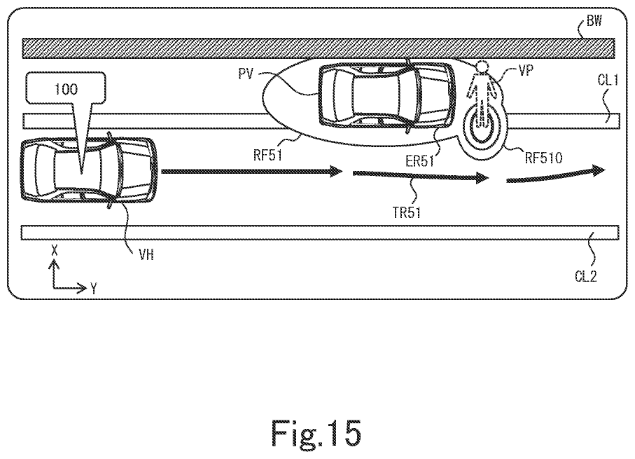

FIGS. 15 to 17 are conceptual diagrams for explaining a fifth example of the driver assistance control by the driver assistance system 100. The fifth example of the driver assistance control is an example of the explicit risk avoidance control. In the fifth example, a parked vehicle PV is in a roadside zone between a left compartment line CL1 and an outer block wall BW. The driver assistance system 100 recognizes the parked vehicle PV, which is in front of the vehicle VH and which may collide with the vehicle VH, as an explicit risk target ER51, ER52, ER53.

In the fifth example, the driver assistance system 100 extracts target information relating to the parked vehicle PV, which is the explicit risk target ER51, ER52, ER53, from peripheral situation information as risk target information. Incidentally, the parked vehicle PV is a potential risk target that is an explicit risk target that may collide with the vehicle VH, and also is a potential risk target that creates a blind area from the vehicle VH.

The collision risk caused by the parked vehicle PV is a risk of colliding with the vehicle VH when the parked vehicle starts moving. The case where a driver is in the parked vehicle PV has a high possibility that the parked vehicle PV starts moving than the case where the parked vehicle PV is unmanned. Although no driver being detected does not imply that the parked vehicle PV is unmanned, the parked vehicle PV will start moving with a higher possibility when a driver is actually detected. Incidentally, the driver in the parked vehicle PV can be detected from the image of the camera.

Further, when the driver is in the parked vehicle PV, the case where the driver is doing some operation has a high possibility that the parked vehicle PV starts moving than the case where the driver is not doing any operation. The lighting of the brake lamp is an operation of the driver which is visually detectable. The possibility that the parking vehicle PV starts moving is higher when the lighting of the brake lamp is detected than when the lighting of the brake lamp is not detected. Incidentally, the lighting of the brake lamp can be detected from the image of the camera.

In the fifth example, the driver assistance system 100 obtains information relating to the presence or absence of the driver in the parked vehicle PV, which is the explicit risk target ER51, ER52, ER53, as influence factor information. Further, the driver assistance system 100 obtains information relating to the presence or absence of the lighting of the brake lamp of the parked vehicle PV as the influence factor information. In the example shown in FIG. 15, the driver is not detected in the parked vehicle PV, and the lighting of the brake lamp is not detected. The driver assistance system 100 obtains, as the influence factor information, that the driver is not detected and that the brake lamp of the parked vehicle PV is not lighting.

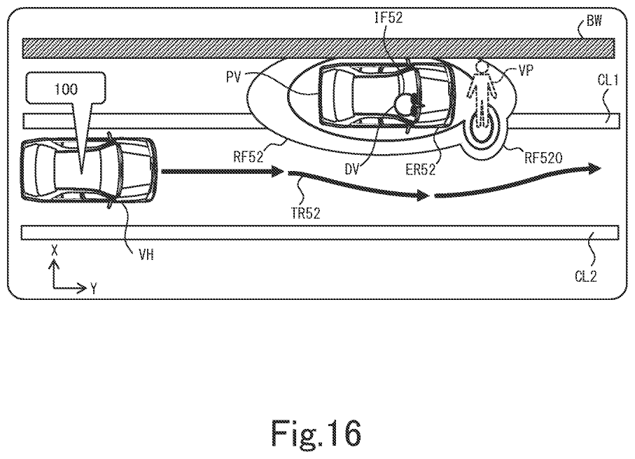

In the example shown in FIG. 16, the driver DV is detected in the parked vehicle PV. However, the lighting of the brake lamp is not detected. In the example shown in FIG. 16, the presence of the driver DV is an influence factor IF52 which influences the collision risk caused by the parked vehicle PV. The driver assistance system 100 obtains the presence of the driver DV in the parked vehicle PV as the influence factor information.

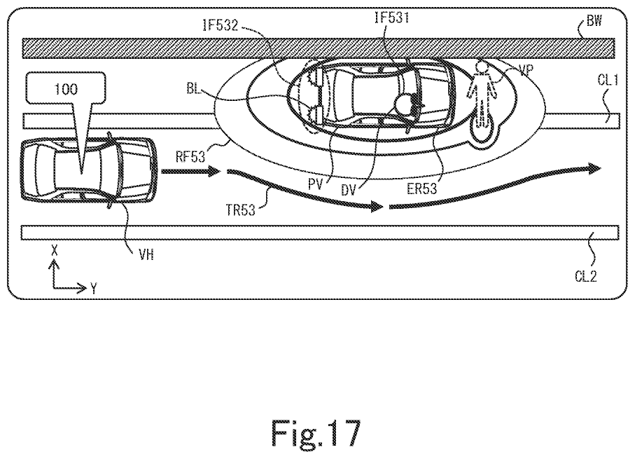

In the example shown in FIG. 17, the driver DV is detected in the parked vehicle PV. In addition, the lighting of the brake lamp BL is also detected. In the example shown in FIG. 17, the presence of the driver DV is an influence factor IF531 which influences the collision risk caused by the parked vehicle PV. The lighting of the brake lamps BL also becomes an influential factor IF532 which influences the collision risk caused by the parked vehicle PV. The driver assistance system 100 obtains that the driver DV is in the parked vehicle PV and that the brake lamp BL is lighting as the influence factor information.

Based on the risk target information and the influence factor information, the driver assistance system 100 generates a risk potential field RF51, RF52, RF53 spreading around the parked vehicle PV, which is the explicit risk target ER51, ER52, ER53. In the example shown in FIG. 15, since there is no influence factor that increase the possibility of the parked vehicle PV to move, the driver assistance system 100 generates the risk potential field RF51 having a standard size determined from the risk target information of the parked vehicle PV. In addition, since the parked vehicle PV, which is the explicit risk target ER51, is also a potential risk target, the driver assistance system 100 also generates a risk potential field RF510 spreading around the virtual pedestrian VP, which is assumed to be in the blind spot of the parked vehicle PV.

In the example shown in FIG. 16, since the driver DV is in the parked vehicle PV, the possibility that the parked vehicle PV starts moving is higher as compared with the example shown in FIG. 15, the collision risk is also higher. The driver assistance system 100 generates the risk potential field RF52 enlarged than the risk potential field RF51 set in the example shown in FIG. 15. The driver assistance system 100 also generates the risk potential field RF520 spreading around the virtual pedestrian VP in the blind spot of the parked vehicle PV.

In the example shown in FIG. 17, the driver DV is in the parked vehicle PV. Further, since the brake lamp BL is also lilting, the possibility that the parked vehicle PV starts moving is further higher as compared with the example shown in FIG. 16, the collision risk is also further higher. The driver assistance system 100 generates the risk potential field RF53 enlarged than the risk potential field RF52 set in the example shown in FIG. 16. The driver assistance system 100 also generates a risk potential field spreading around the virtual pedestrian VP in the blind spot of the parked vehicle PV. However, in the example shown in FIG. 17, the risk potential field centered on the virtual pedestrian VP is covered by the large risk potential field RF53 generated around the parked vehicles PV.

In the example shown in FIG. 15, the driver assistance system 100 generates a target trajectory TR51 of the vehicle VH based on the risk potential field RF51, RF510, Specifically, in the example shown in FIG. 15, the target trajectory TR51 is generated so as not to interfere with the risk potential field RF51 set around the parked vehicle PV and the risk potential field RF510 set around the virtual pedestrian VP. The driver assistance system 100 determines the manipulated variables of the respective actuators so that the vehicle VH follows the target trajectory TR51.

In the example shown in FIG. 16, the driver assistance system 100 generates a target trajectory TR52 of the vehicle VH based on the risk potential field RF52, RF520. Specifically, in the embodiment shown in FIG. 16, the target trajectory TR52 is generated so as to bypass the enlarged risk potential field RF52. The driver assistance system 100 determines the manipulated variables of the respective actuators so that the vehicle VH follows the target trajectory TR52.

In the example shown in FIG. 17, the driver assistance system 100 generates a target trajectory TR53 of the vehicle VH based on the risk potential field RF53. Specifically, in the embodiment shown in FIG. 17, the target trajectory TR53 is generated so as to largely bypass the enlarged risk potential field RF53. The driver assistance system 100 determines the manipulated variables of the respective actuators so that the vehicle VH follows the target trajectory TR53.

### 3-6. Example 6

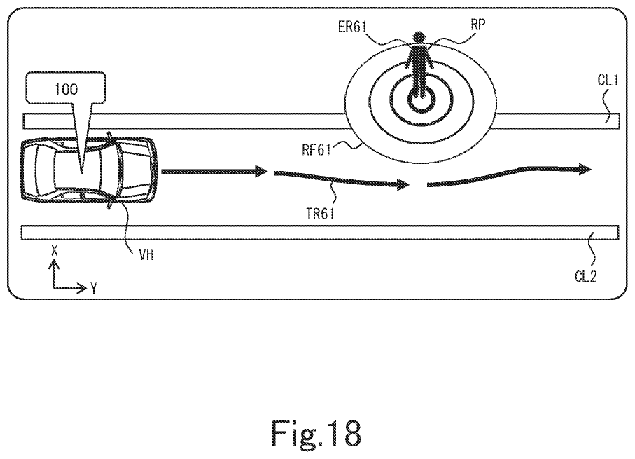

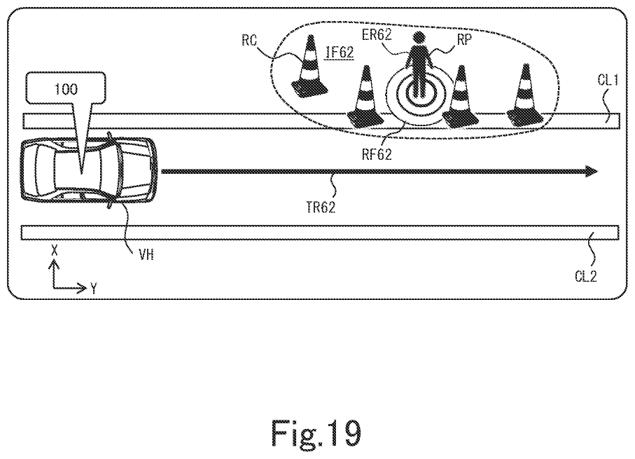

FIGS. 18 and 19 are conceptual diagrams for explaining a sixth example of the driver assistance control by the driver assistance system 100. The sixth example of the driver assistance control is an example of the explicit risk avoidance control. In the sixth example, there is a real pedestrian RP outside the left side of a compartment line CL1. The driver assistance system 100 recognizes the pedestrian RP, which is in front of a vehicle VH and may collide with the vehicle VH, as an explicit risk target ER61, ER62.

In the sixth embodiment, the driver assistance system 100 extracts target information relating to the pedestrian RP, which is the explicit risk target ER61, ER62, from peripheral situation information as risk target information.

The collision risk caused by the pedestrian RP is influenced by the condition of the road where the pedestrian RP is located. For example, if a roadway is separated from a sideway by guardrails, curbs, poles, or the like, the collision risk caused by the pedestrian RP on the sideway is reduced compared to the case without such a structure. Also, at a road construction site surrounded by multiple road cones RC as in the example shown in FIG. 19, the collision risk caused by the pedestrian RP is reduced because the pedestrian RP is unlikely to go out of the road cones RC.

In the sixth example, the driver assistance system 100 obtains, as influence factor information, information relating to the state of the road on which the explicit risk target object ER61, ER62 is detected. In the example shown in FIG. 18, there is nothing around the pedestrian RP, which is the explicit risk target ER61, that may prevent the pedestrian RP from entering the roadway. The driver assistance system 100 obtains as the influence factor information that there is nothing preventing the pedestrian RP from moving freely on the road where the pedestrian RP is detected.

In the example shown in FIG. 19, where the pedestrian RP is located is within the road construction site, and multiple road cones RC separating the road construction site from the roadway are detected around the pedestrian RP. In the example shown in FIG. 19, the condition of the road on which the pedestrian RP stands is the road construction site, which is an influence factor IF62 that influences the collision risk caused by the pedestrian RP. The driver assistance system 100 obtains, as the influence factor information, that the road where the pedestrian RP is detected is the road construction site. The information relating to the influence factors IF62 can be obtained from, for example, camera images, or can be obtained from road traffic information transmitted from a road traffic information system.

Based on the risk target information and the influence factor information, the driver assistance system 100 generates a risk potential field RF61, RF62 spreading around the pedestrian RP, which is the explicit risk target ER61, ER62. In the example shown in FIG. 18, since there is no influence factor that prevent the pedestrian RP from moving, the driver assistance system 100 generates the risk potential field RF61 having a standard magnitude determined from the risk target information of the pedestrian RP.

In the example shown in FIG. 19, the pedestrian RP stands at the site of road construction surrounded by the road cones RC. The pedestrian RP in the road construction, i.e. a worker is unlikely to move beyond the road cones RC towards the roadway. In other words, it is unlikely that the pedestrian RP will jump toward the traveling lane in comparison with the example shown in FIG. 18, and the collision risk caused by the pedestrian RP is also low. The driver assistance system 100 generates the risk potential field RF62 more reduced than the risk potential field RF61 set in the example shown in FIG. 18.

The driver assistance system 100 generates a target trajectory TR61, TR62 of the vehicle VH based on the risk potential field RF61, RF62. In the example shown in FIG. 18, the target trajectory TR61 is generated to bypass the risk-potential field RF61 spreading to the traveling lane. The driver assistance system 100 determines the manipulated variables of the respective actuators so that the vehicle VH follows the target trajectory TR61. In the example shown in FIG. 19, since the risk potential field RF62 is limited to an area surrounded by road cones RC, the target trajectory TR62 is generated along the center of the traveling lane. The driver assistance system 100 determines the manipulated variables of the respective actuators so that the vehicle VH follows the target trajectory TR62.

### 3-7. Example 7

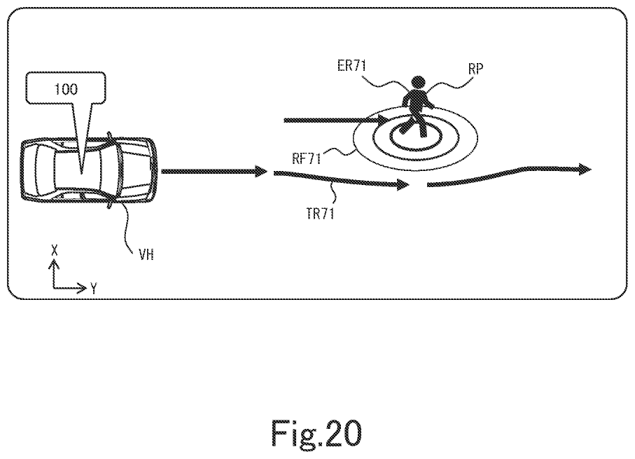

FIGS. 20 to 22 are conceptual diagrams for explaining a seventh example of the driver assistance control by the driver assistance system 100. The seventh example of the driver assistance control is an example of the explicit risk avoidance control. In the seventh example, there is a pedestrian RP on a road without a compartment line. The driver assistance system 100 recognizes the pedestrian RP, which is in front of a vehicle VH and may collide with the vehicle VH, as an explicit risk target ER71, ER72, ER73.

In the seventh example, the driver assistance system 100 extracts target information relating to the pedestrian RP, which is the explicit risk target ER71, ER72, ER73, from peripheral situation information as risk target information.

The collision risk caused by the pedestrian RP is influenced by a time and place at which the pedestrian RP is detected. More specifically, the combination of the time and place influences the collision risk caused by the pedestrian RP. For example, when compared to the case where the pedestrian RP is walking in a place that is not a downtown in the daytime, the case where the pedestrian RP is walking in a downtown at night has a higher risk that the vehicle VH collides with the pedestrian RP. This is because the pedestrian RP may be drunk. In addition, the combination of the time and place with the movement of the pedestrian RP can further enhance the estimation accuracy of the collision risk. For example, when compared to the pedestrian RP who walks straight through a downtown at night, the pedestrian RP who walks while wandering is more likely to be drunk, and the collision risk is even higher.

In the seventh example, the driver assistance system 100 obtains information relating to the time and place at which the pedestrian RP as the explicit risk target ER71, ER72, ER73 is detected as influence factor information. Furthermore, the driver assistance system 100 also obtains information relating to the past position history of the pedestrian RP as the influence factor information. From the past position history, it can be determined whether the pedestrian RP is walking straight or wandering. Of the influence factor information, information relating to the place can be obtained from map information, and information relating to the time can be obtained from a built-in clock of the controller 20. The past position history of the pedestrian RP can be obtained from the target information of the pedestrian RP.

In the example shown in FIG. 20, the pedestrian RP, which is the explicit risk target ER71, walks straight in a place that is not a downtown in the daytime. The driver assistance system 100 obtains, as the influence factor information, that the time when the pedestrian RP is detected is daytime, that the place where the pedestrian RP is detected is a place that is not a downtown, and that the pedestrian RP is walking straight.

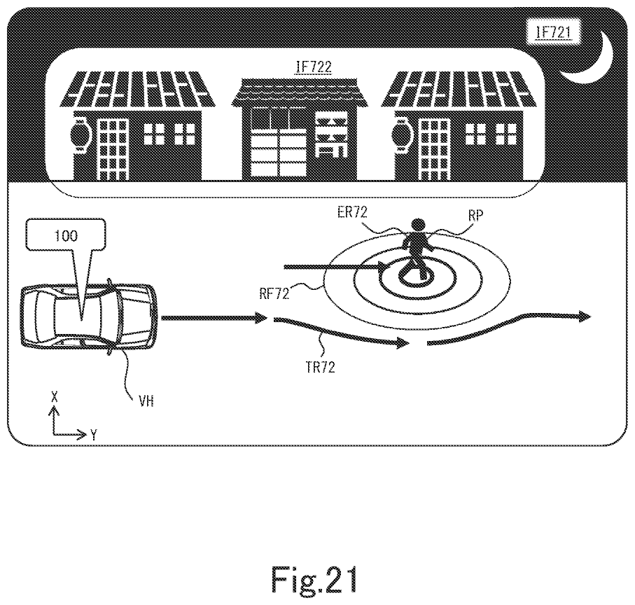

In the example shown in FIG. 21, the pedestrian RP, which is the explicit risk target ER72, walks straight through a downtown at night. Nighttime as a time is detected as an influence factor IF721 that influences the collision risk caused by the pedestrian RP. The downtown as a place is also detected as an influence factor IF722 that influences the collision risk caused by the pedestrian RP. The driver assistance system 100 obtains, as the influence factor information, that the time when the pedestrian RP is detected is nighttime, that the place where the pedestrian RP is detected is in the downtown, and that the pedestrian RP is walking straight.

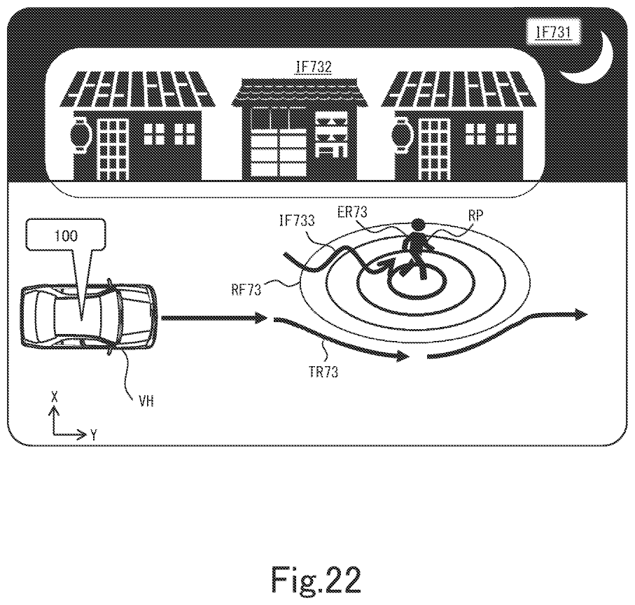

In the example shown in FIG. 22, the pedestrian RP, which is the explicit risk target ER73, walks while wandering in the downtown at night. Nighttime as a time is detected as an influence factor IF731 that influences the collision risk caused by the pedestrian RP. The downtown as a place is also detected as an influential IF732 that influences the collision risk caused by the pedestrian RP. In addition, wandering as a position history is also detected as an influence factor IF733 that influences the collision risk caused by the pedestrian RP. The driver assistance system 100 obtains, as the influence factor information, that the time when the pedestrian RP is detected is nighttime, that the place where the pedestrian RP is detected is the downtown, and that the pedestrian RP walks while wandering.

Based on the risk target information and the influence factor information, the driver assistance system 100 generates a risk potential field RF71, RF72, RF73 spreading around the pedestrian RP, which is the explicit risk target ER71, ER72, ER73. In the example shown in FIG. 20, there is no influence factor indicating the possibility that the pedestrian RP is drunk. For this reason, the driver assistance system 100 generates the risk potential field RF71 having a standard size determined from the risk target information of the pedestrian RP.

In the example shown in FIG. 21, since the pedestrian RP is walking in the downtown at night, the possibility that the pedestrian RP is drunk is greater than the example shown in FIG. 20. When the pedestrian RP is drunk, the vehicle VH may not be noticed due to the deterioration of the judgment ability. Thus, the higher the possibility that the pedestrian RP is drunk, the greater the collision risk. Therefore, the driver assistance system 100 generates the risk potential field RF72 spreading greater to all directions compared to the risk potential field RF71 set in the example shown in FIG. 20.

In the example shown in FIG. 22, since the pedestrian RP is walking in the downtown at night and the foot of the pedestrian RP is unsteady, the possibility that the pedestrian RP is drunk is even greater than the example shown in FIG. 21. If the pedestrian RP is drunk enough to flutter his foot, the pedestrian RP may move unpredictably. Thus, the greater the possibility that the pedestrian RP is drunk, the greater the collision risk. Therefore, the driver assistance system 100 generates the risk potential field RF73 spreading greater to all directions compared to the risk potential field RF72 set in the example shown in FIG. 21.

The driver assistance system 100 generates a target trajectory TR71, TR72, TR73 of the vehicle VH based on the risk potential field RF71, RF72, R73. In the example shown in FIG. 20, the target trajectory TR71 is generated so as not to interfere with the risk potential field RF71 set around the pedestrian RP. The driver assistance system 100 determines the manipulated variables of the respective actuators so that the vehicle VH follows the target trajectory TR71. In the embodiment shown in FIG. 21, the target trajectory TR72 is generated so as to bypass the enlarged risk potential field RF72. The driver assistance system 100 determines the manipulated variables of the respective actuators so that the vehicle VH follows the target trajectory TR72. In the embodiment shown in FIG. 22, the target trajectory TR73 is generated so as to largely bypass the enlarged risk potential field RF73. The driver assistance system 100 determines the manipulated variable of the respective actuators so that the vehicle VH follows the target trajectory TR73.

### 4. Other Embodiments

In determining the risk value obtained by quantifying the collision risk, the risk field disclosed in JP2017-206117A may be calculated instead of the risk potential field.

The above-described examples of the potential risk avoidance control can be implemented in combination as appropriate. The above-described examples of the explicit risk avoidance control can be implemented in combination as appropriate. Furthermore, each of the above-described examples of the potential risk avoidance control and each of the above-described examples of the explicit risk avoidance control may be implemented in combination as appropriate.

What is claimed is:

1. A driver assistance system for assisting driving of a vehicle, comprising:
at least one memory storing at least one program; and
at least one processor coupled with the at least one memory,
wherein the at least one program is configured to cause the at least one processor to execute:
extracting, from information relating to a peripheral situation of the vehicle, risk target information relating to a risk target that is an existence causing a collision risk to the vehicle;
obtaining influence factor information relating to an influence factor that is a factor existing separately from the risk target and influencing the collision risk;
determining a risk value obtained by quantifying the collision risk based on the risk target information and the influence factor information; and
determining, based on the risk value, a manipulated variable of an actuator for controlling movement of the vehicle so as to decrease the collision risk.

2. The driver assistance system according to claim 1,
wherein the at least one program is configured to cause the at least one processor to execute extracting, as the risk target information, information relating to a potential risk target that is present in front of the vehicle and creates a blind spot from the vehicle.

3. The driver assistance system according to claim 1,
wherein the at least one program is configured to cause the at least one processor to execute extracting, as the risk target information, information relating to an explicit risk target that is present in front of the vehicle and has a possibility of colliding with the vehicle.

4. The driver assistance system according to claim 2,
wherein the at least one program is configured to cause the at least one processor to execute obtaining, as the influence factor information, information relating to a peripheral environment of the potential risk target.

5. The driver assistance system according to claim 2,
wherein the at least one program is configured to cause the at least one processor to execute obtaining, as the influence factor information, information relating to a moving object present behind the potential risk target.

6. The driver assistance system according to claim 2,
wherein the at least one program is configured to cause the at least one processor to execute obtaining, as the influence factor information, information relating to a dynamic factor acting on the blind spot formed by the potential risk target.

7. The driver assistance system according to claim 2,
wherein the at least one program is configured to cause the at least one processor to execute obtaining, as the influence factor information, information relating to a time and place at which the potential risk target is detected.

8. The driver assistance system according to claim 3,
wherein:
the explicit risk target is a parked vehicle; and
the at least one program is configured to cause the at least one processor to execute obtaining, as the influence factor information, information relating to presence or absence of a driver in the parked vehicle.

9. The driver assistance system according to claim 3,
wherein the at least one program is configured to cause the at least one processor to execute obtaining, as the influence factor information, information relating to a state of a road on which the explicit risk target is detected.

10. The driver assistance system according to claim 3,
wherein the at least one program is configured to cause the at least one processor to execute obtaining, as the influence factor information, information relating to a time and place at which the explicit risk target is detected.

11. A driver assistance method for assisting driving of a vehicle, comprising:
extracting, from information relating to a peripheral situation of the vehicle, risk target information relating to a risk target that is an existence causing a collision risk to the vehicle;
obtaining influence factor information relating to an influence factor that is a factor existing separately from the risk target and influencing the collision risk;
determining a risk value obtained by quantifying the collision risk based on the risk target information and the influence factor information; and
determining, based on the risk value, a manipulated variable of an actuator for controlling movement of the vehicle so as to decrease the collision risk.

12. A computer readable storage medium storing a program configured to cause a processor to execute processing, the processing comprising:
extracting, from information relating to a peripheral situation of a vehicle, risk target information relating to a risk target that is an existence causing a collision risk to the vehicle;
obtaining influence factor information relating to an influence factor that is a factor existing separately from the risk target and influencing the collision risk;
determining a risk value obtained by quantifying the collision risk based on the risk target information and the influence factor information; and
determining, based on the risk value, a manipulated variable of an actuator for controlling movement of the vehicle so as to decrease the collision risk.
